(19) United States
(12) Patent Application Publication
(10) Pub. No.: US 2009/0027196 A1
(43) Pub. Date: Jan. 29, 2009

(54) SYSTEM AND METHOD FOR PREMISES MONITORING AND CONTROL USING SELF-LEARNING DETECTION DEVICES

(76) Inventor: Roland Schoettle, American Canyon, CA (US)

Correspondence Address: FULBRIGHT & JAWORSKI L.L.P, 2200 ROSS AVENUE, SUITE 2800, DALLAS, TX, 75201-2784, US

(21) Appl. No.: 11/923,176

(22) Filed: Oct. 24, 2007

Related U.S. Application Data
(63) Continuation-in-part of application No. 11/683,308, filed on Mar. 7, 2007.

(51) Int. Cl. G08B 13/00

(52) U.S. Cl. 340/541

(57) ABSTRACT

The present invention is directed to systems and methods in which monitors track their respective parameters. Based on the learned activity, the monitors control operational aspects of the premises. The monitors thus learn and remember how the premises is used. When a possible trouble condition is detected, the system compares a detected parameter against parameters expected at that day and time in order to determine the action to be taken. In one embodiment the system learns and remembers the cyclical repetition and frequency of parameters, for example, of someone with a cane or limp, or a small person with a short gait as compared to a tall person with a longer stride.

### CROSS-REFERENCE TO RELATED APPLICATIONS

This application is a continuation-in-part of U.S. patent application Ser. No. 11/683,308, Attorney Docket No. 66816/P015US/10614005, filed Mar. 7, 2007, entitled ‘SYSTEM AND METHOD FOR PREMISES MONITORING USING WEIGHT DETECTION,” the disclosure of which is hereby incorporated herein by reference.

### TECHNICAL FIELD

The present disclosure is directed to the use of premises monitoring and control devices. More specifically, the present disclosure is directed to systems and methods for premises monitoring and control using self-learning devices.

### BACKGROUND OF THE INVENTION

Monitoring or security systems are well known in a variety of areas. Monitoring systems are often found in areas or premises where the owner desires to maintain security, or to track movements such as in a home, a business, or a prison. A typical monitoring system includes a series of contact sensors that are linked to a control panel. When a sensor is tripped (i.e., contact broken or closed) the control panel receives a signal and activates an alarm. Some of these monitoring systems include sound, weight, etc. These sensors respond to various stimuli for detecting a trouble condition. When designing a security system, the user must determine what stimuli are to be monitored and then place the sensors at the appropriate locations in order to properly detect a “violation” of the sensor(s). One aspect of such sensor selection and/or placement is an understanding of the parameters of what is to be measured. Sensors are designed for specific ranges (such as detecting when a temperature exceeds a fixed number, or the temperature rises faster than a certain rate) and thus the user selects the proper anticipated parameters for each sensor.

These fixed parameter systems work well in many situations, but cannot be tuned to specific situations. For example, the task of automatically turning off (or on) lights in various rooms in a premises at first seems straightforward. One can use motion sensors and/or timers. Motion sensors suffer from the fact that they cause lights to go on/off at awkward times. Timers, on the other hand, once set are predictable. However, this predictability becomes a nuisance on, for example, Saturday night, when the family remains active several hours longer than on other nights of the week. One solution is to use a 7-day programmable timer assuming the user pre-knows the times of usage for each day of the week. Such a solution will work, but is cumbersome and perhaps costly.

The problem just described is even more pronounced where temperature, air movement, weight, light, chemicals, noise, etc. are to be monitored. For example, the situation where smoke is routinely present (say on a factory floor) for at certain times, while this same smoke at other times is a trouble condition, is difficult to monitor.

In some situations, ambiguity exists as to a particular action that should be taken at a particular time. For example, as discussed above, when a pet moves in a room the motion sensor senses the motion and sounds the alarm. However, had the motion sensor “known” for sure that a pet was present in the monitored area, or that a rightful occupant of the premises was moving through the area at that time, then the detected motion could be safely ignored.

### BRIEF SUMMARY OF THE INVENTION

The present invention is directed to systems and methods in which monitors track their respective parameters. Based on the learned activity, the monitors control operational aspects of the premises. The monitors thus learn and remember how the premises is used. When a possible trouble condition is detected, the system compares a detected parameter against parameters expected at that day and time in order to determine the action to be taken. In one embodiment the system learns and remembers the cyclical repetition and frequency of parameters, for example, of someone with a cane or limp, or a small person with a short gait as compared to a tall person with a longer stride. In some embodiments, information obtained by one sensor is used together with information learned from another sensor to fashion a composite learned understanding of a premises. Examples of sensors include (but are not limited to) light, power, temperature, RF signals, schedulers, clocks, sound, vibration, motion, pressure, voice, proximity, occupancy, location, velocity, safety, security, fire, smoke, messages, medical condition, identification signals, humidity, barometric pressure, weight, traffic pattern sensors, power quality sensors, operating costs, power factor sensors, storage capacity, distributed generation capacity, UPS capacity, battery monitoring, inertia, glass break, flood, carbon dioxide, carbon monoxide, ultrasound, infra-red, microwave, radiation, microbe, bacteria, virus, germ, disease sensors, poison sensors, toxic material sensors, air quality sensors, laser sensors, load sensors, load control systems, etc.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a block diagram of one embodiment illustrating an example premises;

FIG. 2 is an example of a flow diagram illustrating steps performed during training; and

FIG. 3 is an example of a flow diagram illustrating steps performed during monitoring.

### DETAILED DESCRIPTION OF THE INVENTION

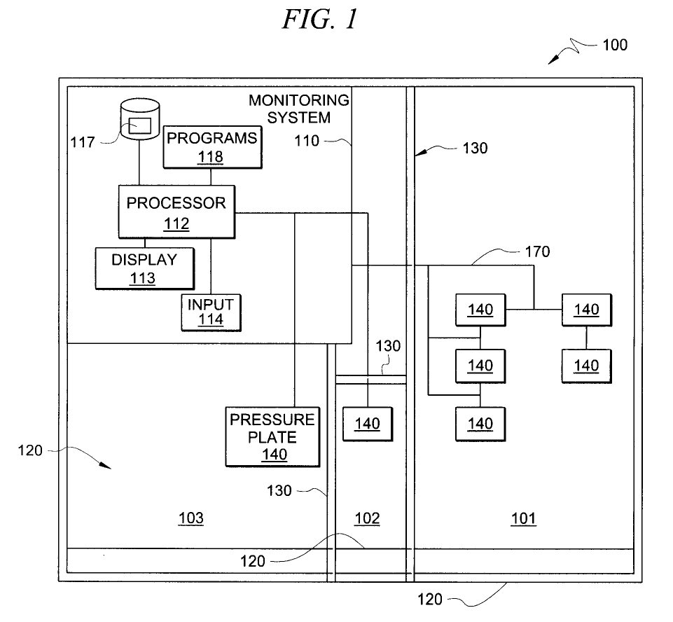

FIG. 1 is a block diagram of one embodiment illustrating premises 100 having pressure monitoring system 110 (as discussed above, many other sensor types can be used). In this embodiment, premises 100 is a home. However, other premises can be used such as a warehouse, a prison, an office, etc. Premises 100 illustratively includes, in addition to monitoring system 110, floor 120, walls 130, and a plurality of pressure plates 140.

Monitoring system 110 is, in one embodiment, a system that can monitor the movement of persons, animals and/or objects through the premises. In one illustrative embodiment, monitoring system 110 includes processor 112, data storage device 117, and monitoring program(s) 118.

Pressure plates 140 are pressure sensitive plates that are located at one or more locations throughout premises 100. The pressure plate can, if desired, be designed to appear as floor tiles or other indigenous objects found in the premises. The tiles are placed in a pattern common to a home or other premises at locations of strategic importance. Pressure plates 140 can be made of any material, such as ceramic, linoleum, wood, carpet, or concrete. In some embodiments, pressure plates 140 can be located on walls 130 or built into switches, etc. By having pressure plates located on a wall it is possible for the monitoring system to determine if the walls are being contacted by something. For example, in a warehouse wall sensors could indicate if a stack has shifted and is leaning on a wall. When multiple sensors are used, they can be arranged such that the progress of movement can be determined.

A variety of different types of pressure sensors can be used. For example, the pressure sensor can be a displacement type sensor that deforms or moves a distance depending upon the load (weight, pressure) applied to the sensor. In some situations it might be desirable to calibrate the sensor using, for example, a known weight or set of weights. The displacement of the sensor is converted to an electrical signal which is either converted to a weight value at the sensor or sent to monitoring system 110 for translation. Communication of signals among the sensors and processor 112 can be wireline or wireless or a combination thereof. In some embodiments, each sensor 140 can have a unique identifier which is then transmitted along with the weight or displacement signal to the monitoring system. In other embodiments, more data can be passed to the monitoring system as desired. For the purposes of this embodiment, the term pressure sensor includes impact and low shock sensors.

Processor 112 can be, for example, a personal computer or a dedicated or embedded computer system. Processor 112 can be connected to display device 1113, as well as to one or more input devices 114. Input device 114 can be, for example, a keyboard or a mouse. In one embodiment, display 113 and input 114 are combined as a touch screen. Display 113 allows the user of the monitoring system to interact with and monitor various components of the monitoring system. Through the use of input device 114 the user can change the mode of the monitoring system. However, input device 114 can, in additional embodiments, turn on or off sensors, create or delete zones, control other systems, or otherwise customize the monitoring system, as is well-known.

Processor 112 interacts with data storage device 117. Data storage device 117 is in one embodiment a database, such as a Structured Query Language (SQL) database. However, any type of database structure can be used.

In operation, monitoring system 110 can track the premises, perhaps in conjunction with other sensors (not shown) to record a pattern of behavior. This pattern can be stored to form a basis for statistical analysis for “anticipation” purposes. The pattern can be, for example, sensor 140 outside the back door sends a signal that a weight is noted. By itself this is not a problem. But then assume a motion sensor in the back hall detects motion. A presumption can be made that someone has entered the premises. Now, depending upon the time of day, or by whether or not the system is armed, a trouble condition can be identified.

Assume further that sensors 140 in a pattern across the premises are showing weight placed thereon. Again, this could be a trouble condition. But now assume that a first sensor 140 in the master bedroom showed a weight signal followed by a light going on (or another pressure sensor coming active) in the master bath. This in all likelihood is not a trouble condition. However, if this last sequence had been received, i.e., the master bath is sensed before the master bedroom, a different condition exists. For example, someone could have entered in through a window, which is abnormal.

By using actual weight measurements, i.e., 30 pounds in the hallway, an assumption can be made that a child (or pet) is moving about. In this situation, the signal from the motion sensor could be ignored, all controlled, for example, by a program contained in the system.

By using actual accelerometer and/or impact/shock patterns versus distance measurement, i.e., a 200 pound person running (using for example; impact “G”s, speed, direction, stride length), an assumption can be made that an adult male is moving about, or conversely that a child is not moving about. In this situation, the signal from the accelerometer could signal either or both conditions simultaneously and trigger the appropriate response(s).

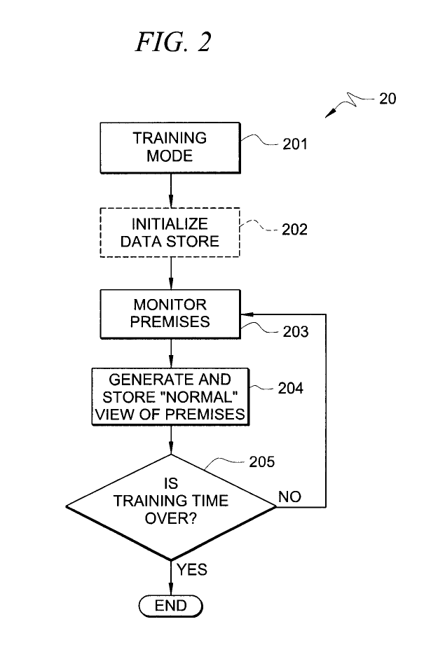

Monitoring program 118 is, in one embodiment, software or other program that allows for the monitoring of the premises. This program 118 is, in one embodiment, stored on computer 112. In another embodiment, the program can be stored in data storage device 117. However, program 118 can be stored at a remote location, if desired. One mode of operation is a monitoring (measurement) mode, and a second mode can be, if desired, a training mode, a third mode can be, if desired, a control mode, and a fourth mode can be, if desired, a verification mode. In the training mode, monitoring program 118 receives data from each of the sensors. An example of the training process will be discussed in greater detail with respect to FIG. 2.

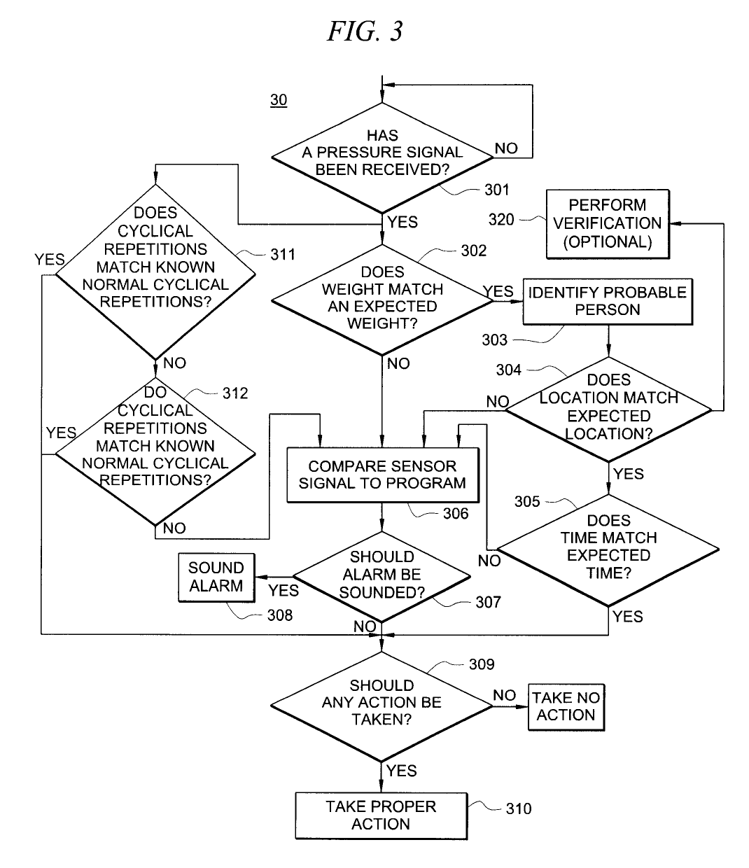

In the monitoring mode, monitoring system 110 receives data related to the current condition of the pressure sensor. This received data is compared to data in data store 117 (if any) to determine if the current data matches a “normal” pattern for this time. If the received data is within acceptable tolerances to the data in data store 117 then monitoring system 110 does not react. However, if the data is outside acceptable tolerances, monitoring system 110 will provide an alert to a user or monitor. As discussed above, the monitoring system can be programmed to determine the direction of movement. In one embodiment, the direction, speed, and acceleration of movement can be determined by comparing the results of successive pressure readings across a number of sensors 140. A more detailed description of the monitoring mode is provided with respect to FIG. 3.

In some embodiments, premises 100 may be divided into a number of zones. These zones allow the user of the system to further customize the system. Zones may be desired to monitor the movement of items in a warehouse, or to prevent the moving of large items from one area to another area. Further, zones can be used to segregate areas in a security system. However, other uses for zones can be implemented.

When system 110 is divided into zones, such as zones 101, 102, 103, data store 117 can be used to configure each sensor 140 with a particular zone. In other embodiments, data store 117 can be divided into a number of separate data stores, where each zone has a separate data store. Monitoring program 118 can define which sensors are in which zone. Further, the user can define zones that exist (or are active) only during certain times. For example, the user may want a zone for evening hours only, but not during the day. Or the user may desire to separate the sleeping areas of a home from the living areas. In this example, the monitoring system would alert the user, if for example, abnormal weight or movement was detected in the living areas. However, the system could be programmed to provide an alert if abnormal activity is detected in the sleeping areas of the premises, as this could be indicative of a child awakening, and moving toward a parent's bedroom.

In order to achieve the above results, monitoring system 110 can be programmed and/or trained to learn how the premises is normally used. FIG. 2 illustrates steps performed when training the monitoring system.

The system can be further programmed, for known normal conditions, known abnormal conditions, and for unknown conditions. Each condition can take into account, for example, user, user type (e.g., animal or human), time, zone, softness of impact an/or shock patterns, stride length, gait, and many more. Another embodiment, for example, could also take into account (either separately or together with the information already listed) such information as light, power, temperature, RF signals, time, schedule, sound, vibration, motion, voice, proximity, occupancy, location, velocity, safety, security, fire, smoke, messages, medical condition, identification, humidity, barometric pressure, weight, traffic patterns, power quality, operating cost, power factor, storage capacity, distributed generation capacity, UPS capacity, battery monitoring, inertia, glass break, flood, carbon dioxide, carbon monoxide, ultrasound, infra-red, microwaves, radiation, microbes, bacterium, viruses, germs, diseases, poisons, toxic materials sensors, air quality sensors, laser sensors, load sensors, load control systems, etc.

In the training mode, the monitoring system receives data for storage so that at a later time a newly arriving data can be compared to the stored data to determine normal and abnormal situations.

In the control mode, the system receives data that causes some control action, such as a signal to increase temperature, or turn off power to an area.

In the verification mode, the system performs a verification, such as focusing a camera on an area or such as checking to see if a child is still in his/her bedroom when a “SOFT” footstep is detected.

As shown in FIG. 2, step 201 of embodiment 20 places the monitoring system in a training mode. This training mode is optional and any desired parameters, such as weights of expected people, times of certain activities, etc., can be entered into the program.

Process 202 optionally initializes data store 117 to ensure that any previous data in data store 117 is flushed properly since data remaining from an earlier session could cause a system error in analyzing any data received during monitoring. One reason for not initializing data store 117 is if the monitoring system is being trained for a specific purpose, such as prior to a short term vacation, or other purpose, where it may be desirable to later use previously stored values.

Once data store 117 has been initialized, process 203 monitors the premises to receive pressure readings from the various sensors located in the premises. Based on these monitored readings over a period of time, process 204 generates a “normal” view of the premises. This normal set of readings is stored, for example, in storage 117 (FIG. 1).

Process 205 determines when the training time has ended and when it has then process 20 ends. In some embodiments the training mode can be configured to automatically stop after a predetermined period of time. The predetermined period of time can be a day, a week, a month, or anytime. Training can also be based on other factors, such as the number of events over a weekend, etc. However, in most embodiments the period of time would be between a day and a few weeks.

FIG. 3 illustrates one embodiment of a process, such as process 30, executed by monitoring system 110 when in the monitor mode. Initially monitoring system 110 is in a standby state so long as no sensors are tripped. In a typical monitoring system there is an “armed” and “unarmed” mode. During the unarmed mode, the system is essentially off. However, using the concepts taught herein, the monitoring can be armed all the time but program 118 will then control what actions, if any, the system will take when a sensor sends a signal.

Process 301 determines if a pressure signal (or any other signal of possible concern) has been received. This process, where possible, determines which sensor is sending the signal and gathers all of the available parameters (such as, for example, the actual weight being placed on the sensor). When a signal has been received, process 302 determines, for example, by using the trained stored data, or from pre-programmed data, whether or not the weight matches an expected weight. If so, then process 303 identifies the probable person. This can be accomplished, for example, by comparing the detected weight against a list of known weights for person's living in the household or for persons expected on the premises. Process 304 then determines if the identified person belonging to the matched weight belongs at the location of the detection. Thus a 40 lb weight matching that of a son can be anticipated to be outside his bedroom door, but not in the laundry room. Process 305 works in conjunction with process 304 so as to modify the location match. For example, the son might be expected in the hallway at 3 AM but not in the garage.

Process 320 can, if desired, perform verification, for example, an unexpected weight, impact or shock pattern on specific areas enables a camera to focus on the correct area and then to take a photograph which can then be sent electronically for review (either automatically or by a person) and possible action.

If either process 304 or 305 (or any other similar filter type process) determines an unanticipated event, then the information is fed to process 306 where the sensor data (perhaps over a period of time) is communicated to process 306 where the system application program (or other processing) determines if an alarm is to be sounded. This processing could, for example, take into account the direction of travel (based on a series of received sensor signals from different ones of the sensors over a period of time); the time, the temperature, etc.

By way of example, if several sensors in an area all begin to send pressure signals at the exact same time an assumption can be made that something fell in that area. Or, as discussed above, a certain weight is moving in the “wrong” direction, as determined by process 306, then a trouble condition can be assumed. Any number of such “wrong” combinations then can be detected, all based, at least in part, on the sensing of pressures being applied at different locations.

Process 307 determines, based on information from process 306, if an alarm is to be sounded. If so, then process 308 sounds the alarm. In situations where the alarm is not to be sounded, then process 309 determines what action, if any, should be taken and process 310 takes the necessary action. This action could be to wake a parent, turn on a light, call a care-taker or a doctor, all based on the pre-established guidelines created by or for a user.

In some situations, cyclical repetitions of a sensed parameter can be used by processes 311 and 312 to determine if a trouble condition exists. These repetitions can be known normal or known abnormal and so long as they are known they will not be counted as a problem. Known abnormal could be, for example, a freight train comes by at 2 a.m. and rattles the windows. This is an “abnormal” condition at all times, except it is anticipated at 2 a.m. and thus, at that time is known abnormal and thus allowable.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system comprising:
at least one sensor;
a memory for storing a plurality of sensor readings from said sensor over a period of time; and
a processor for determining, based on stored ones of said sensor readings, that a condition exists with respect to a current sensor reading that warrants action to be taken.

2. The system of claim 1 wherein said stored sensor readings include other parameters associated with said sensor readings and wherein said determining is based, at least in part, on said parameters associated with both said current reading and said stored readings.

3. The system of claim 2 wherein said other parameters are selected from the list consisting of:
time of receipt of one or more readings, number of sensors sending readings, types of sensors, types of readings, relative locations of various sensors sending readings, cyclical repetitions, event duration, number of simultaneous readings.

4. The system of claim 2 wherein said system comprises a communications system capable of communicating with other said systems.

5. The system of claim 4 wherein said communications system collects and sends messages including other parameters associated with said sensor readings of other such said systems and wherein said determining is based, at least in part, on said parameters associated with other such said systems with any combination of current readings of said system, current readings from other such said systems, stored readings of said system, and stored readings from any other such said systems.

6. The system of claim 1 further comprising:
a program for establishing a set of guidelines representative of an anticipated sensor signal that falls within an expected focus of activity; and
wherein said determining is based on said established set of guidelines.

7. The system of claim 6 wherein said guidelines are established by a training process.

8. The system of claim 6 wherein said guidelines are established for a control purpose.

9. The system of claim 6 wherein said guidelines are established for a verification purpose.

10. The system of claim 6 wherein said guidelines are pre-established by a user based on said user's preferences.

11. The system of claim 6 wherein said guidelines are based on a predetermined condition.

12. The system of claim 6 wherein said guidelines are based on unknown or unexpected conditions.

13. The system of claim 6 further comprising:
at least one control switch; and
wherein said guidelines include therein a guideline to operate said switch in relationship to a received signal from said sensor as well as from other said sensors.

14. The system of claim 6 further comprising:
at least one power control switch; and
wherein said guidelines include therein a guideline to operate said switch in relationship to a received signal from said sensor.

15. A method for detecting a trouble condition with respect to a premises, said method comprising:
receiving a signal that corresponds to a parameter being monitored at certain positions pertaining to said premises;
creating over time an anticipated pattern of normal activity of said parameter based upon said received signal; and
determining from said received signal in conjunction with said created anticipated pattern of normal activity that said trouble condition exists with respect to said premises.

16. The method of claim 15 wherein said determining is based, at least in part, on at least one of the following:
a time of receipt of said received signal;
the magnitude of said received signal;
the type of said received signal;
a comparison of said received signal with receipt of a signal representative of another action occurring with respect to said premises.

17. The method of claim 16 wherein said anticipated pattern of normal activity for a particular time are determined, at least in part, from one of the following:
by pre-training;
from a user supplied input instruction.

18. The method of claim 16 wherein said other action selected from the list consisting of:
power switch operation, motion sensor detection, premises physical breach detection, sound detection, vibration, light levels, CO₂ levels, temperature, movement pattern detection, voltage, frequency, impedance, RF signals, time, schedule, voice, proximity, occupancy, location, velocity, fire, smoke, electronic messages, medical condition detection, user identification, humidity, barometric pressure, weight, power quality, operating cost, power factor, storage capacity, generation capacity, UPS capacity, battery capacity, inertia, glass break, flooding, CO levels, phasors, ultrasound, infra-red, microwaves, radiation, microbes, bacterium, viruses, germs, diseases, poisons, toxic materials sensors, air quality sensors, laser sensors, load sensors, stress sensors.

19. The method of claim 15 wherein said determining is based, at least in part, on at least one of the following:
a cyclical repetition;
an event's duration;
on an event's type;
a number of simultaneous readings from a plurality of sources.

20. An alert system comprising;
means for detecting a parameter occurring at a specific location of a premises;
means for comparing a detected parameter with a previously detected parameter occurring at the same time on a previous day; and
means for reporting a possible trouble condition based on said comparing.

21. The alert system of claim 20 wherein said comparing means compares an action sensor parameter of a previous time period to an action sensor parameter of a corresponding time period of a selected time.

22. The alert system of claim 21 further comprising:
means for creating a set of anticipation data to be used by said comparing means to assist in said reporting.

23. The alert system of claim 22 wherein said anticipation data comprises at least one type of data selected from the list consisting of:
time data, anticipated measured parameters; locations of anticipated parameters; direction of progression from one location to another of said anticipated weights; number of sensors sending signals; relative locations of various sensors sending signals; magnitude of parameters being applied to a sensor; shock patterns; cyclical repetitions; impact strength; impact duration; path taken; expected path to be taken; speed; velocity; event duration; number of simultaneous readings; power switch operation, motion sensor detection, premises physical breach detection, sound detection, vibration, light levels, CO₂ levels, temperature, movement pattern detection, voltage, frequency, impedance, RF signals, time, schedule, voice, proximity, occupancy, location, velocity, fire, smoke, electronic messages, medical condition detection, user identification, humidity, barometric pressure, weight, power quality, operating cost, power factor, storage capacity, generation capacity, UPS capacity, battery capacity, inertia, glass break, flooding, CO levels, phasors, ultrasound, infra-red, microwaves, radiation, microbes, bacterium, viruses, germs, diseases, poisons, toxic materials sensors, air quality sensors, laser sensors, load sensors, stress sensors.
